(19) United States
(12) Patent Application Publication
(10) Pub. No.: US 2026/0296197 A1
(43) Pub. Date: Oct. 1, 2026

(54) VEHICLE CONTROL DEVICE AND CONTROL METHOD

(71) Applicant: HONDA MOTOR CO., LTD., Tokyo (JP)

(72) Inventors: Keiki OKANO, Tokyo (JP); Shohei NOAI, Tokyo (JP); Shoei TOMIKAWA, Tokyo (JP); Ryo MUKAINAKANO, Tokyo (JP)

(73) Assignee: HONDA MOTOR CO., LTD., Tokyo (JP)

(21) Appl. No.: 19/578,904

(22) Filed: Mar. 26, 2026

(30) Foreign Application Priority Data
Mar. 28, 2025 (JP) 2025-055948

(51) Int. Cl. B60K 35/28; B60K 35/21

(52) U.S. Cl. CPC B60K 35/28; B60K 35/21; B60K 2360/166

(57) ABSTRACT

A vehicle control device includes a processor configured to: acquire peripheral information of the vehicle; recognize a peripheral situation of the vehicle based on the acquired peripheral information; and a controller configured to guide an occupant of the vehicle to a travel region ahead of the vehicle in a travel direction thereof by displaying the travel region on a display based on a recognition result. In a predetermined situation where an oncoming lane whose travel direction is opposite to that of an own lane, and a central division line is not present or the central division line is not able to be detected, the controller displays, as the travel region, a predetermined region on an own lane side between road boundary lines on left and right sides of the roadway, and displays a region on an oncoming lane side with respect to the predetermined region as a non-travel region.

### CROSS-REFERENCE TO RELATED APPLICATIONS

This application is based on and claims priority under 35 USC 119 from Japanese Patent Application No. 2025-055948 filed on Mar. 28, 2025, the contents of which are incorporated herein by reference.

### TECHNICAL FIELD

The present disclosure relates to a vehicle control device and a control method.

### BACKGROUND

In recent years, improvements in traffic safety have been required to enable inclusion, safety, toughness, and sustainability of urban and human residents. From a viewpoint of improving the traffic safety, for example, developments of driving assistance techniques and autonomous driving techniques for vehicles have been advanced.

As an example of the driving assistance techniques, the following Japanese Patent Application Laid-Open Publication No. 2021-077227 discloses a technique in which, when it is determined by a space determination unit that "there is a passing space", a vehicle front video including a virtual own vehicle is created and displayed on a monitor device, and a recommended travel route as driving assistance information is superimposed on the vehicle front video as an image with the virtual own vehicle as a reference and is stereoscopically depicted.

Further, the following Japanese Patent Application Laid-Open Publication No. 2005-202787 discloses a technique in which information on traffic regulations and instructions corresponding to a road ahead of an own vehicle is acquired, a degree of attention indicating a degree to which a user is to pay attention to the road ahead of the own vehicle is determined based on the information on the traffic regulations and instructions, a display image indicating a region of the road whose display mode varies depending on the degree of attention is generated, and the display image is displayed at a position of the road in a display region of a windshield.

It is also assumed that a central division line that separates an own lane in which the vehicle travels and an oncoming lane is not present, or the vehicle cannot detect the central division line for some reason although the central division line is present.

In the related-art techniques, a behavior of the vehicle under such a situation has not been sufficiently studied, and there is room for improvement in this point.

The present disclosure provides a vehicle control device and a control method capable of assisting, even if a central division line that separates an own lane in which a vehicle travels and an oncoming lane is not present or the central division line cannot be detected, the vehicle in traveling in an appropriate region on a roadway including the own lane and the oncoming lane.

### SUMMARY

A first aspect of the present disclosure relates to a vehicle control device for controlling a vehicle. The vehicle control device includes: a processor configured to: acquire peripheral information of the vehicle; recognize a peripheral situation of the vehicle based on the acquired peripheral information; and a display controller configured to guide an occupant of the vehicle to a travel region ahead of the vehicle in a travel direction thereof by displaying the travel region on a display of the vehicle based on a recognition result. In a predetermined situation in which an oncoming lane whose travel direction is opposite to that of an own lane in which the vehicle travels is present on a roadway including the own lane, and a central division line that separates the own lane and the oncoming lane is not present or the central division line is not able to be detected, the display controller displays, as the travel region, a predetermined region on an own lane side between road boundary lines on left and right sides of the roadway, and displays a region on an oncoming lane side with respect to the predetermined region as a non-travel region that is not the travel region.

A second aspect of the present disclosure relates to a vehicle control device for controlling a vehicle. The vehicle includes: a processor configured to: acquire peripheral information of the vehicle; recognize a peripheral situation of the vehicle based on the acquired peripheral information acquired; and perform first control including at least one of steering control or acceleration and deceleration control for causing the vehicle to travel along an own lane based on road boundary lines in a periphery of the vehicle. In a predetermined situation in which an oncoming lane whose travel direction is opposite to that of the own lane in which the vehicle travels is present on a roadway including the own lane and a central division line that separates the own lane and the oncoming lane is not present or the central division line is not able to be detected, the processor performs the first control preferentially using, among the road boundary lines on left and right sides of the roadway, the road boundary line on an own lane side over the road boundary line on an oncoming lane side.

A third aspect of the present disclosure relates to a control method to be performed by a computer for controlling a vehicle. The control method includes: acquiring peripheral information of the vehicle; recognizing a peripheral situation of the vehicle based on the acquired peripheral information; and guiding an occupant of the vehicle to a travel region ahead of the vehicle in a travel direction thereof by displaying the travel region on a display unit of the vehicle based on a recognition result for the peripheral situation. The guiding includes: in a predetermined situation in which an oncoming lane whose travel direction is opposite to that of an own lane in which the vehicle travels is present on a roadway including the own lane, and a central division line that separates the own lane and the oncoming lane is not present or the central division line is not able to be detected, displaying a predetermined region on an own lane side between road boundary lines on left and right sides of the roadway as the travel region, and displaying a region on an oncoming lane side with respect to the predetermined region as a non-travel region that is not the travel region.

A fourth aspect of the present disclosure relates to a control method to be performed by a computer for controlling a vehicle. The control method includes: acquiring peripheral information of the vehicle; recognizing a peripheral situation of the vehicle based on the acquired peripheral information; and performing first control including at least one of steering control or acceleration and deceleration control for causing the vehicle to travel along an own lane based on recognized road boundary lines in a periphery of the vehicle. The performing includes: in a predetermined situation in which an oncoming lane whose travel direction is opposite to that of the own lane in which the vehicle travels is present on a roadway including the own lane and a central division line that separates the own lane and the oncoming lane is not present or the central division line is not able to be detected, performing the first control preferentially using, among the road boundary lines on left and right sides of the roadway, the road boundary line on an own lane side over the road boundary line on an oncoming lane side.

According to the present disclosure, it is possible to provide a vehicle control device and a control method capable of assisting, even if the central division line that separates the own lane in which the vehicle travels and the oncoming lane is not present or the central division line cannot be detected, the vehicle in traveling in an appropriate region on the roadway including the own lane and the oncoming lane.

### BRIEF DESCRIPTION OF DRAWINGS

Exemplary embodiment(s) of the present invention will be described in detail based on the following figures, wherein:

FIG. 1 is a block diagram showing a schematic configuration of a vehicle 1 including a control device 30 according to an embodiment;

FIG. 2 is a diagram (part 1) showing a specific example of a travel region guidance screen G1 in the present embodiment;

FIG. 3 is a diagram (part 2) showing the specific example of the travel region guidance screen G1 in the present embodiment;

FIG. 4 is a diagram showing a specific example of an LKAS (first control) of the present embodiment;

FIG. 5 is a diagram showing a specific example of RDM (second control) of the present embodiment;

FIG. 6 is a flowchart showing an example of a process performed by the control device 30; and

FIG. 7 is a flowchart showing another example of the process performed by the control device 30.

### DESCRIPTION OF EMBODIMENTS

Hereinafter, an embodiment of a vehicle control device and a control method of the present disclosure will be described with reference to the drawings. The following embodiment does not limit the present disclosure, and not all elements described in the following embodiment are essential to the present disclosure. Further, two or more elements described in the following embodiment may be freely combined without departing from the gist of the present disclosure. Hereinafter, the same or similar elements are denoted by the same or similar reference signs, and a description thereof may be omitted or simplified.

### VEHICLE

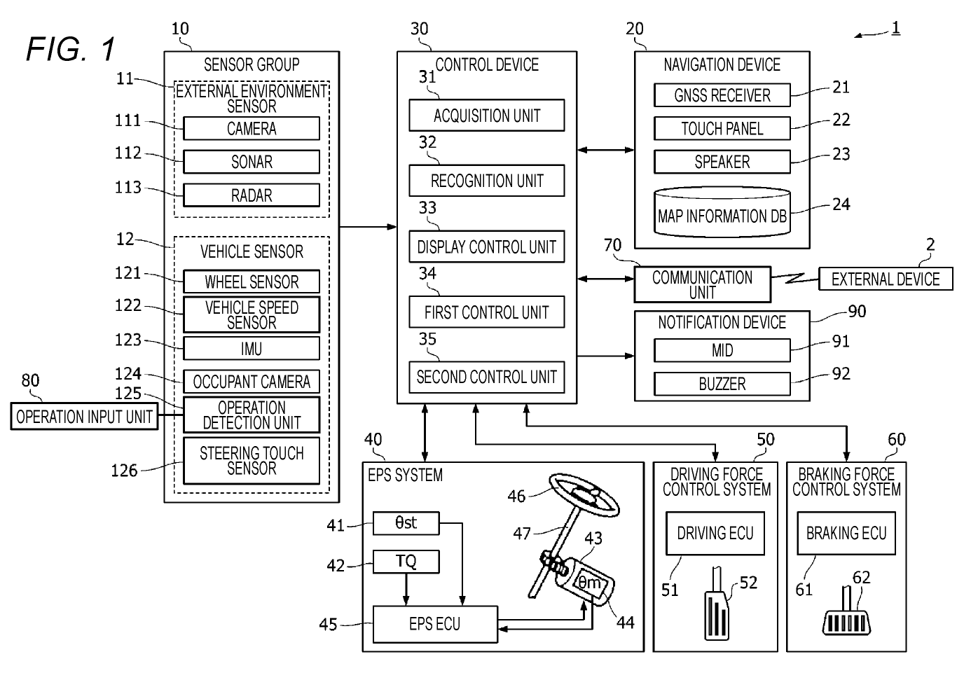

First, a vehicle including a control device 30, which is an embodiment of a vehicle control device of the present disclosure, will be described. A vehicle 1 shown in FIG. 1 is an automobile including a drive source (not shown), and wheels (not shown) including drive wheels driven by power of the drive source and steered wheels that are steerable. As an example, the vehicle 1 may be a four-wheeled automobile including a pair of left and right front wheels and a pair of left and right rear wheels.

The drive source of the vehicle 1 may be an electric motor, an internal combustion engine such as a gasoline engine or a diesel engine, or a combination of an electric motor and an internal combustion engine. The drive source of the vehicle 1 may drive the pair of left and right front wheels, the pair of left and right rear wheels, or the four wheels including the pair of left and right front wheels and the pair of left and right rear wheels. The front wheels and the rear wheels of the vehicle 1 may all be steerable steered wheels, or the front wheels or the rear wheels may be steerable steered wheels.

The vehicle 1 includes a sensor group 10, a navigation device 20, the control device 30 that is an example of the vehicle control device of the present disclosure, an electric power steering (EPS) system 40, a driving force control system 50, a braking force control system 60, a communication unit 70, an operation input unit 80, and a notification device 90.

The sensor group 10 includes an external environment sensor 11 that acquires peripheral information of the vehicle 1, and a vehicle sensor 12 that acquires information related to the vehicle 1. Information (in other words, a detection value) acquired by each sensor in the sensor group 10 is output to the control device 30, and is used for control on the vehicle 1 (hereinafter, also referred to as "vehicle control") performed by the control device 30.

The external environment sensor 11 includes, for example, cameras 111, a sonar 112, and a radar 113. Each of the cameras 111 is a digital camera that images a periphery of the vehicle 1 including a front side of the vehicle 1 and outputs image data of an obtained peripheral image to the control device 30. As the camera 111, for example, a digital camera using an imaging element such as a charge coupled device (CCD) or a complementary metal oxide semiconductor (CMOS) can be adopted.

The sonar 112 emits sound waves to the periphery of the vehicle 1 (for example, the front side, a rear side, and lateral sides of the vehicle 1), and receives reflected sounds from an object present in the periphery of the vehicle 1, thereby detecting a distance to the object, an azimuth of the object, and the like. The radar 113 emits radio waves to the periphery of the vehicle 1 including the front side of the vehicle 1, and receives reflected waves from an object present in the periphery of the vehicle 1, thereby detecting a distance to the object, an azimuth of the object, and the like. As the radar 113, for example, a millimeter wave radar can be adopted.

The external environment sensor 11 may include light detection and ranging (LiDAR) instead of or in addition to the sonar 112 and the radar 113. In this case, the LiDAR emits laser light to the periphery of the vehicle 1 including the front side of the vehicle 1, and receives reflected light from an object present in the periphery of the vehicle 1, thereby detecting a distance to the object, an azimuth of the object, and the like.

The vehicle sensor 12 includes, for example, a wheel sensor 121, a vehicle speed sensor 122, an inertial measurement unit (IMU) 123, an occupant camera 124, an operation detection unit 125, and a steering touch sensor 126.

The wheel sensor 121 detects a rotation angle of one or more wheels among the wheels of the vehicle 1. As an example, the wheel sensor 121 detects rotation angles of a left rear wheel and a right rear wheel. As the wheel sensor 121, for example, an angle sensor or a displacement sensor can be adopted.

The vehicle speed sensor 122 detects a vehicle speed VP that is a travel speed of the vehicle 1 (in other words, a movement speed of a vehicle body). For example, the vehicle speed sensor 122 detects the vehicle speed VP based on a rotation speed of a counter shaft (not shown) provided in the vehicle 1.

The inertial measurement unit 123 detects angular velocities of the vehicle 1 in a pitch direction, a roll direction, and a yaw direction, and accelerations of the vehicle 1 in a front-rear direction, a left-right direction, and an upper-lower direction. The vehicle sensor 12 may include, instead of the inertial measurement unit 123, an acceleration sensor that detects an acceleration of the vehicle 1 in a predetermined direction and a gyro sensor that detects an angular velocity of the vehicle 1 in a predetermined direction.

The occupant camera 124 is a digital camera that images an interior of the vehicle 1 and outputs image data of an obtained interior image to the control device 30. For example, the occupant camera 124 may be a so-called "driver monitor camera" that is capable of imaging a head of an occupant who sits on the driver's seat of the vehicle 1 (hereinafter, also referred to as a "driver") from the front (in other words, imaging a face). Similar to the camera 111, a digital camera using an imaging element such as a CCD or a CMOS can be employed as the occupant camera 124. In the present embodiment, the image data of the vehicle interior image obtained by the occupant camera 124 imaging the vehicle interior is information that can specify an orientation of a line of sight of the driver.

The operation detection unit 125 detects an operation performed by using the operation input unit 80 that is operable by the driver. In the present embodiment, the operation input unit 80 may include, for example, an operation button (not shown) for receiving an operation to switch between on (in other words, operation) and off (in other words, non-operation) of an LKAS to be described later. In this case, the operation detection unit 125 can detect the operation of turning on/off the LKAS.

The steering touch sensor 126 detects whether a steering 46 of the vehicle 1 is gripped appropriately. For example, the steering touch sensor 126 is implemented by a capacitance sensor or the like. In this case, the capacitance sensor is provided at a portion touched by the driver when the steering 46 is gripped appropriately.

The navigation device 20 includes, for example, a global navigation satellite system (GNSS) receiver 21, a touch panel 22, and a speaker 23. The navigation device 20 includes a storage unit (not shown) implemented by a flash memory or the like. The storage unit of the navigation device 20 stores a map information database (DB) 24 and the like.

The GNSS receiver 21 specifies a current position of the vehicle 1 (for example, a latitude and a longitude of a location where the vehicle 1 is located) based on a signal received from a GNSS satellite. For example, the navigation device 20 may acquire a detection result of the vehicle sensor 12 (for example, the wheel sensor 121 or the vehicle speed sensor 122) via the control device 30, and specify or complement the current position of the vehicle 1 by an inertial navigation system (INS) using a detection value of the vehicle sensor 12.

The touch panel 22 is implemented by, for example, combining a display device such as a liquid crystal display or an organic light emitting diode (OLED) with a pointing device (for example, a touch pad). The speaker 23 is configured to output a sound to the occupant (for example, the driver) of the vehicle 1.

For example, the navigation device 20 searches for a route from the current position of the vehicle 1 to a destination set by the driver using the touch panel 22, by referring to the map information database 24. Then, the navigation device 20 performs route guidance using the touch panel 22 and the speaker 23 based on the found route. The navigation device 20 may cause the touch panel 22 to perform a predetermined display according to an instruction from the control device 30. Further, for example, the navigation device 20 may output, to the control device 30, predetermined information such as information indicating the specified current position of the vehicle 1 or information indicating an operation received via the touch panel 22.

The control device 30 is a computer that includes, for example, a processor that performs various calculations, a storage unit having a non-transitory storage medium for storing various types of information, and an input and output unit that controls input and output of data between the inside and the outside of the control device 30 (none is shown), and generally controls the entire vehicle 1. For example, the control device 30 is implemented by one electronic control unit (ECU) or by a plurality of ECUs working in cooperation with each other. Since the control device 30 will be described later, the description thereof will be omitted here.

The EPS system 40 includes, for example, a steering angle sensor 41, a torque sensor 42, an EPS motor 43, a resolver 44, and an EPS ECU 45.

The steering angle sensor 41 detects a steering angle θst of the steering 46 and outputs information indicating the detected steering angle θst to the EPS ECU 45. The torque sensor 42 detects a steering torque TQ, which is a torque applied to the steering 46 of the vehicle 1, and outputs information indicating the detected steering torque TQ to the EPS ECU 45.

The EPS motor 43 assists the driver in operating the steering 46 by applying, according to an instruction from the EPS ECU 45, a driving force or a reaction force to a steering column 47 connected to the steering 46. The resolver 44 detects a rotation angle θm of the EPS motor 43 and outputs information indicating the detected rotation angle θm to the EPS ECU 45.

The EPS ECU 45 is a computer which includes, for example, a processor that performs various calculations, a storage unit including a non-transitory storage medium that stores various types of information, and an input and output unit that controls input and output of data between the inside and the outside of the EPS ECU 45 (none is shown), and controls the EPS system 40 (for example, the EPS motor 43). The EPS ECU 45 is implemented by one or two or more ECUs. For example, the EPS ECU 45 controls the EPS system 40 (for example, the EPS motor 43) based on the steering angle θst detected by the steering angle sensor 41, the steering torque TQ detected by the torque sensor 42, the rotation angle θm detected by the resolver 44, and the like.

The EPS system 40 (for example, the EPS ECU 45) may output, to the control device 30, information indicating the steering angle θst detected by the steering angle sensor 41, the steering torque TQ detected by the torque sensor 42, the rotation angle θm detected by the resolver 44, and the like. Further, the EPS system 40 (for example, the EPS ECU 45) may output information indicating a steering speed ω of the steering 46 to the control device 30. In this case, the steering speed ω is obtained by, for example, differentiating the steering angle θst with respect to time.

The driving force control system 50 includes a driving ECU 51, and is configured to control a driving force of the vehicle 1. The driving ECU 51 is a computer that includes, for example, a processor that performs various calculations, a storage unit including a non-transitory storage medium that stores various types of information, and an input and output unit that controls input and output of data between the inside and the outside of the driving ECU 51 (none is shown), and controls the driving force control system 50. The driving ECU 51 is implemented by one or more ECUs. For example, based on an operation on an accelerator pedal 52 provided in the vehicle 1, the driving ECU 51 controls the power output from the drive source of the vehicle 1. The driving ECU 51 can also control the driving force control system 50 (for example, the drive source) according to an instruction from the control device 30.

The braking force control system 60 includes a braking ECU 61, and is configured to control a braking force of the vehicle 1. The braking ECU 61 is a computer that includes, for example, a processor that performs various calculations, a storage unit including a non-transitory storage medium that stores various types of information, and an input and output unit that controls input and output of data between the inside and the outside of the braking ECU 61 (none is shown), and controls the braking force control system 60. The braking ECU 61 is implemented by one or more ECUs. For example, the braking ECU 61 controls the braking force of the vehicle 1 by controlling a brake device (not shown) provided in the vehicle 1, based on an operation on a brake pedal 62 provided in the vehicle 1. Here, the brake device includes, for example, a brake caliper, a cylinder that transmits a hydraulic pressure to the brake caliper, and an electric motor that generates a hydraulic pressure in the cylinder. The braking ECU 61 controls an electric motor of the brake device such that a braking force corresponding to the operation on the brake pedal 62 is generated. The braking ECU 61 can also control the braking force control system 60 (for example, the brake device) according to an instruction from the control device 30.

The communication unit 70 is a communication interface that communicates with the external device 2 under control of the control device 30. That is, the control device 30 may communicate with the external device 2 via the communication unit 70. Examples of the external device 2 can include a terminal device (for example, a smartphone) of the driver and a server device managed by a manufacturer of the vehicle 1. For example, a mobile communication network such as a cellular line, WI-FI (registered trademark), or Bluetooth (registered trademark) can be used for communication between the vehicle 1 and the external device 2.

The notification device 90 is a device that notifies the driver of various types of information under control of the control device 30. The notification device 90 includes, for example, a multi-information display (MID) 91 and a buzzer 92. The MID 91 is implemented by, for example, a display device such as a liquid crystal display or an OLED, and is provided at a position that the driver can visually recognize (for example, in a meter panel of the vehicle 1). In the present embodiment, the MID 91 may display a travel region guidance screen G1 and the like to be described later. The MID 91 may be integrated with the touch panel 22 described above. That is, the "MID 91" in the following description may be interpreted as the "touch panel 22".

The buzzer 92 is configured to output, for example, a predetermined sound such as an alarm sound. The buzzer 92 may be integrated with the speaker 23 described above. That is, the "buzzer 92" in the following description may be interpreted as the "speaker 23".

### CONTROL DEVICE

Next, the control device 30 will be described in more detail. The control device 30 includes, for example, an acquisition unit 31, a recognition unit 32, a display control unit 33, a first control unit 34, and a second control unit 35, as functional units implemented by the processor executing programs stored in the storage unit of the control device 30.

The acquisition unit 31 acquires the peripheral information of the vehicle 1. Here, the peripheral information is information for the control device 30 (for example, the recognition unit 32 to be described later) to recognize a peripheral situation of the vehicle 1. For example, the acquisition unit 31 performs sensor fusion processing on detection results of a part or all of the camera 111, the sonar 112, and the radar 113 in the external environment sensor 11, and acquires the peripheral information of the vehicle 1 based on a processing result.

The recognition unit 32 recognizes the peripheral situation of the vehicle 1 based on the peripheral information acquired by the acquisition unit 31. For example, the recognition unit 32 recognizes, as the peripheral situation of the vehicle 1, a division line L on a roadway RD that is a road on which the vehicle 1 travels. The division line L may include a left road boundary line LL that separates a left end portion of the roadway RD and the outside of the roadway RD, a right road boundary line RL that separates a right end portion of the roadway RD and the outside of the roadway RD, a central division line CL, and the like.

Here, the central division line CL is a division line that separates the roadway RD into an own lane SL in which the vehicle 1 travels and an oncoming lane OL whose travel direction is opposite to that of the own lane SL. It is noted that the central division line CL is not necessarily provided at a center of the roadway RD in a width direction thereof. That is, depending on the roadway RD, the central division line CL may be provided to be offset to a left side from the center in the width direction, and the central division line CL may be provided to be offset to a right side from the center in the width direction. Further, depending on the roadway RD, the central division line CL may not be provided, although the own lane SL and the oncoming lane OL are present.

The recognition unit 32 may recognize, as the division line L, any object that may constitute a boundary of the roadway RD, for example, a side groove, a curb, a guardrail, or a median strip, in addition to a white line, an orange line, or the like actually drawn on the roadway RD. That is, the division line L can also be referred to as a boundary between the roadway RD and the outside thereof or a boundary between lanes on the roadway RD.

In addition to the division line L such as the left road boundary line LL, the right road boundary line RL, or the central division line CL, the recognition unit 32 may recognize, for example, other traffic participants (for example, other vehicles or pedestrians), road signs, road markings, obstacles (for example, objects falling on the road), or the like present in the periphery of the vehicle 1. As an example, in the present embodiment, the recognition unit 32 can recognize an oncoming vehicle that is a vehicle traveling in the oncoming lane OL (that is, a vehicle whose travel direction is opposite to that of the vehicle 1).

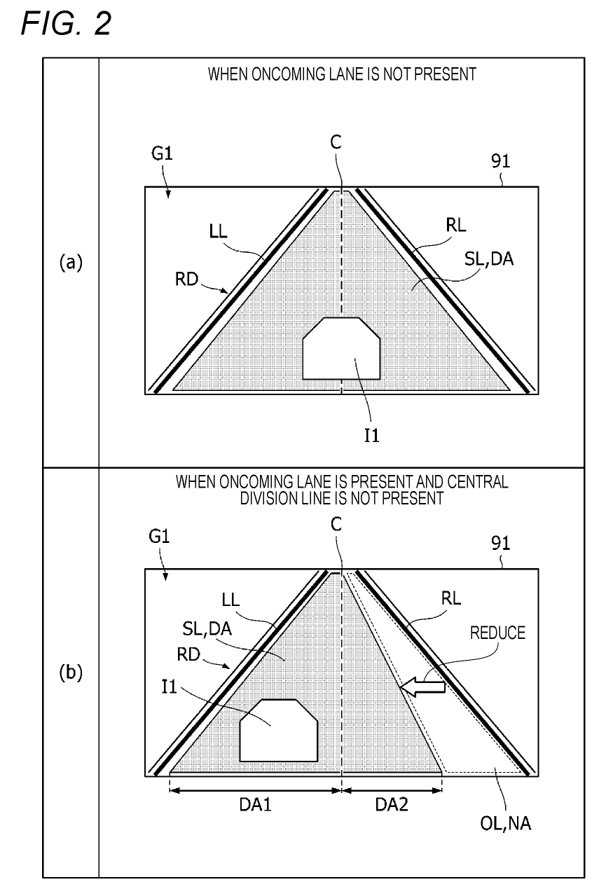

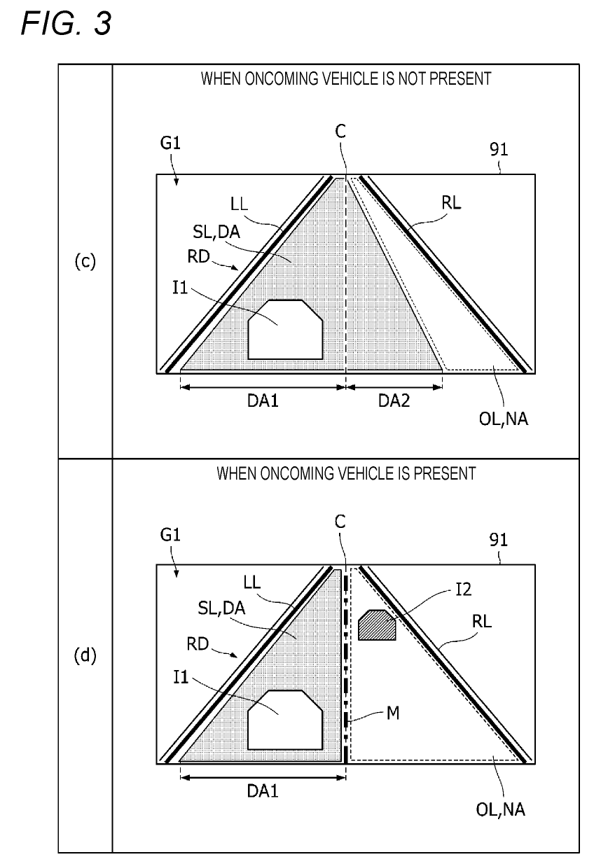

The display control unit 33 displays the travel region guidance screen G1 indicating a travel region DA ahead of the vehicle 1 in the travel direction on the MID 91 as a display unit of the vehicle 1 based on a recognition result of the recognition unit 32, thereby guiding the occupant (for example, the driver) of the vehicle 1 to the travel region DA. Here, the travel region DA is, for example, a region where the vehicle 1 is to travel according to traffic rules (for example, regulations or customs) of a region where the roadway RD is provided. A specific example of the travel region guidance screen G1 displayed by the display control unit 33 will be described later with reference to FIGS. 2 and 3.

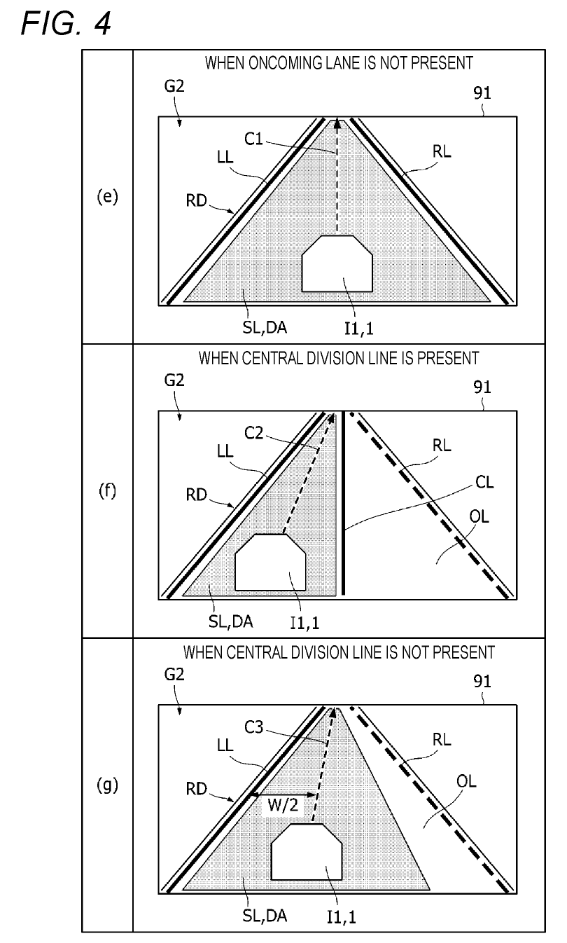

The first control unit 34 is configured to perform, based on the division line L (for example, the left road boundary line LL) in the periphery of the vehicle 1 recognized by the recognition unit 32, first control including at least one of steering control or acceleration and deceleration control for causing the vehicle 1 to travel along the own lane SL. Hereinafter, as the first control, an LKAS (lane keep assist system) for assisting the steering such that the vehicle 1 travels while staying near a center of the own lane SL may be performed. For example, the first control unit 34 performs the LKAS (that is, the first control) based on an operation of turning on the LKAS being detected by the operation detection unit 125. A specific example of the LKAS performed by the first control unit 34 will be described later with reference to FIG. 4 and the like.

The second control unit 35 is configured to perform, based on the division line L (for example, the left road boundary line LL or the right road boundary line RL) in the periphery of the vehicle 1 recognized by the recognition unit 32, second control including at least one of predetermined steering control, acceleration and deceleration control, or notification when the vehicle 1 approaches the division line L (in other words, when there is a risk that the vehicle 1 crosses the division line L). Hereinafter, as the second control, RDM (road departure mitigation) that mitigates departure of the vehicle 1 from the roadway RD may be performed.

Here, the RDM may include, for example, notification control for notifying the driver that the vehicle 1 may depart to an outside of the roadway RD (hereinafter, also referred to as "road outside"), and departure mitigation steering control for controlling the steering of the vehicle 1 such that the vehicle 1 does not depart to the road outside. In the notification control, for example, the second control unit 35 displays a warning image indicating that the vehicle 1 may depart to the road outside on the MID 91, outputs a predetermined warning sound from the buzzer 92, or vibrates the steering. In the departure mitigation steering control, for example, the second control unit 35 controls the steering of the vehicle 1 such that the vehicle 1 moves from the approaching division line L toward an inner side of the roadway RD (for example, the own lane SL). Further, in the RDM, the second control unit 35 may perform, for example, the acceleration and deceleration control for decelerating the vehicle 1 that is likely to depart to the road outside or accelerating the vehicle 1 that moves toward the inner side of the roadway RD.

The second control unit 35 may perform the RDM based on, for example, whether a direction indicator is turned on or not or a TTLC (Time to Line Crossing: a time until the vehicle 1 reaches the division line). That is, for example, the second control unit 35 may perform the RDM when the TTLC is less than a threshold in a state where the direction indicator is not turned on. Since a method of calculating the TTLC is known, a detailed description thereof will be omitted here.

Hereinafter, each of the display control unit 33, the first control unit 34, and the second control unit 35 will be described in more detail.

In the following description, an example of a case where a region where the roadway RD on which the vehicle 1 travels is provided is a left-hand traffic region such as Japan, but the present disclosure is not limited thereto. For example, when the present disclosure is applied with the region where the roadway RD on which the vehicle 1 travels is provided being a right-hand traffic region such as the United States of America or the People's Republic of China, the "right" and "left" in the following description may be interpreted as "left" and "right", respectively, and the reference numerals of the corresponding elements may be interpreted similarly accordingly. Further, FIGS. 2 to 5 and the like may be viewed in a horizontally inverted manner as necessary.

Further, it is noted that the following description of a case where the central division line CL is not present is also applicable to a case where the central division line CL cannot be detected. That is, when the central division line CL cannot be detected, the control device 30 (for example, the display control unit 33, the first control unit 34, or the second control unit 35) may also perform the same control as when the central division line CL is not present in the following description. In other words, "when the central division line CL is not present" in the following description may mean "when the central division line CL is not present or when the central division line CL cannot be detected".

Here, "the central division line CL cannot be detected" means, for example, that the recognition unit 32 cannot recognize the central division line CL. For example, the white line or the like drawn on the roadway RD gradually becomes thinner as time elapses, and may finally become difficult to recognize. Further, when snow or mud is accumulated on the roadway RD, it may be difficult to recognize the white line or the like drawn on the roadway RD. In such a case, a situation in which the recognition unit 32 cannot recognize the central division line CL may occur.

Even if the recognition unit 32 cannot recognize the central division line CL, the control device 30 can determine whether the oncoming lane OL is present on the roadway RD by referring to, for example, map information (for example, the map information database 24) prepared in advance.

### TRAVEL REGION GUIDANCE SCREEN IN PRESENT EMBODIMENT

In the present embodiment, the display control unit 33 may display the travel region guidance screen G1 shown in FIGS. 2 and 3 on the MID 91 or the like based on the recognition result of the recognition unit 32. The travel region guidance screen G1 is a display screen showing the travel region DA ahead of the vehicle 1 in the travel direction. Further, on the travel region guidance screen G1, the display control unit 33 may display the division line L recognized by the recognition unit 32, an own vehicle icon I1 that is an icon representing the vehicle 1, an oncoming vehicle icon I2 representing the oncoming vehicle, and the like.

The display control unit 33 varies the travel region DA on the travel region guidance screen G1 depending on, for example, the presence or absence of the oncoming lane OL, the presence or absence of the central division line CL, and the presence or absence of the oncoming vehicle.

(a) of FIG. 2 shows an example of the travel region guidance screen G1 displayed when the oncoming lane OL is not present on the roadway RD and the roadway RD is only the own lane SL for one-way traffic. In this case, the display control unit 33 displays a region from the left road boundary line LL to the right road boundary line RL as the travel region DA on the travel region guidance screen G1.

The display control unit 33 displays, based on a relative position between the division line L recognized by the recognition unit 32 and the vehicle 1, the own vehicle icon I1 at a position on the travel region guidance screen G1 in consideration of the relative position. For example, in the example shown in (a) of FIG. 2, since the vehicle 1 is traveling substantially at a center in the width direction of the roadway RD, the display control unit 33 displays the own vehicle icon I1 at a position overlapping a broken line C. Here, the broken line C is a virtual line indicating the center in the width direction of the roadway RD on the travel region guidance screen G1.

Although illustration and a detailed description are omitted, when the oncoming lane OL and the central division line CL are present on the roadway RD, the display control unit 33 may display the travel region guidance screen G1 indicating that a region corresponding to the own lane SL is the travel region DA. For example, in this case, the display control unit 33 may display the central division line CL instead of the right road boundary line RL in the example shown in (a) of FIG. 2, and may display the travel region guidance screen G1 in which a region from the left road boundary line LL to the central division line CL is set as the travel region DA.

(b) of FIG. 2 and (c) of FIG. 3 each show an example of the travel region guidance screen G1 displayed when the oncoming lane OL is present on the roadway RD, but the central division line CL is not present, and no oncoming vehicle is present. In this case, the display control unit 33 displays a predetermined region on an own lane SL side between the left road boundary line LL and the right road boundary line RL (that is, the road boundary lines on the left and right sides) of the roadway RD in the travel region guidance screen G1 as the travel region DA, and displays a region on an oncoming lane OL side with respect to the predetermined region as a non-travel region NA that is not the travel region DA. For example, in a left-hand traffic region, the "own lane SL side" is the left side in the width direction of the roadway RD, and the "oncoming lane OL side" is the right side in the width direction of the roadway RD. In a right-hand traffic region, the "own lane SL side" is the right side in the width direction of the roadway RD, and the "oncoming lane OL side" is the left side in the width direction of the roadway RD.

That is, in this case, the display control unit 33 displays the travel region DA reduced in the width direction of the roadway RD on the travel region guidance screen G1 as compared with the case shown in (a) of FIG. 2 by an amount corresponding to the non-travel region NA (see a white arrow shown in (b) of FIG. 2).

More specifically, in this case, the display control unit 33 displays, as the travel region DA, a predetermined region including a first region DA1 on the own lane SL side (that is, a left road boundary line LL side) with respect to a center in the width direction of the roadway RD indicated by the broken line C and a second region DA2 on the oncoming lane OL side (that is, a right road boundary line RL) with respect to the center of the roadway RD.

Here, the first region DA1 is a region wider than the second region DA2 in the width direction of the roadway RD on the travel region guidance screen G1, and has at least a width corresponding to a vehicle width W of the vehicle 1, for example. Meanwhile, a width of the second region DA2 can be appropriately determined by the manufacturer or the like of the vehicle 1, and can be, for example, a width corresponding to half of the vehicle width W (that is, the vehicle width W/2) or a width corresponding to 1 [m].

For example, in the examples shown in (b) of FIG. 2 and (c) of FIG. 3, an entire region on the own lane SL side with respect to the center in the width direction of the roadway RD indicated by the broken line C is set as the first region DA1. Further, the second region DA2 having a width of about half that of the first region DA1 is provided on the oncoming lane OL side from the center in the width direction of the roadway RD indicated by the broken line C.

(d) of FIG. 3 shows an example of the travel region guidance screen G1 displayed when the oncoming lane OL is present on the roadway RD, but the central division line CL is not present, and an oncoming vehicle is present. In this case, the display control unit 33 displays a predetermined region including the first region DA1 described above but not including the second region DA2 as the travel region DA on the travel region guidance screen G1. That is, in this case, the display control unit 33 displays the travel region guidance screen G1 indicating that a region (that is, the first region DA1) on the own lane SL side with respect to the center of the roadway RD indicated by the broken line C is the travel region DA and a region on the oncoming lane OL side with respect to the center of the roadway RD is the non-travel region NA.

When the oncoming lane OL is present on the roadway RD, but the central division line CL is not present, and an oncoming vehicle is present, the display control unit 33 may display a division mark M that separates the own lane SL and the oncoming lane OL in the width direction of the roadway RD, as shown in (d) of FIG. 3. In this case, the division mark M is displayed, for example, at a position overlapping the above broken line C on the travel region guidance screen G1.

That is, as shown in (d) of FIG. 3, when the division mark M is displayed, the display control unit 33 may display, as the travel region DA, a predetermined region including the first region DA1 on the own lane SL (in other words, the left road boundary line LL) side with respect to the division mark M.

In this way, by displaying the division mark M when an oncoming vehicle is present, it is possible to enhance consciousness of the driver to cause the vehicle 1 to travel in a region closer to the left road boundary line LL side with respect to the center in the width direction of the roadway RD, and to assist driving in consideration of the oncoming vehicle.

As shown in (d) of FIG. 3, in this case, based on the relative position between the oncoming vehicle and the vehicle 1 recognized by the recognition unit 32, the display control unit 33 may display the oncoming vehicle icon I2 at a position on the travel region guidance screen G1 in consideration of the relative position. In this way, the awareness of the driver for the oncoming vehicle can be further enhanced, and the driving in consideration of the oncoming vehicle can be assisted.

Although the division mark M shown in (d) of FIG. 3 is linear, a display mode of the division mark M is not limited thereto. For example, the division mark M may be a non-linear shape such as a dot. However, in order to allow the driver to distinguish between the division line L recognized by the recognition unit 32 and the division mark M, the division mark M is preferably displayed in a display mode different from that of the division line L recognized by the recognition unit 32.

### LKAS IN PRESENT EMBODIMENT

(e) of FIG. 4 shows an example of the LKAS (that is, the first control) performed by the first control unit 34 when the oncoming lane OL is not present on the roadway RD (in other words, the roadway RD is only the own lane SL for one-way traffic) and the left road boundary line LL and the right road boundary line RL are recognized by the recognition unit 32 as the division line L.

In this case, the first control unit 34 performs the LKAS using the left road boundary line LL and the right road boundary line RL. Specifically, in this case, the first control unit 34 treats a region from the left road boundary line LL to the right road boundary line RL as the own lane SL, and controls the steering of the vehicle 1 such that the vehicle 1 travels while maintaining near a center in the width direction of the region from the left road boundary line LL to the right road boundary line RL (see an arrow C1 in (e) of FIG. 4).

When the LKAS is performed by the first control unit 34, the display control unit 33 displays an LKAS guidance screen G2 on the MID 91 or the like. Here, the LKAS guidance screen G2 is a display screen for guiding the driver with the division line L used for the LKAS, a region treated as the own lane SL, and the like. For example, the display control unit 33 displays the above travel region guidance screen G1 when LKAS is not performed, and displays the LKAS guidance screen G2 instead of the travel region guidance screen G1 when LKAS is performed.

For example, when the LKAS in the example shown in (e) of FIG. 4 is performed, the display control unit 33 displays the left road boundary line LL and the right road boundary line RL in a first display mode (for example, a display color of green) indicating that the left road boundary line LL and the right road boundary line RL are used for the LKAS on the LKAS guidance screen G2, and guides the driver that the region from the left road boundary line LL to the right road boundary line RL is treated as the own lane SL (in other words, the travel region DA). In this case, the display control unit 33 may guide the driver that the vehicle 1 is traveling while maintaining near the center in the width direction of the region from the left road boundary line LL to the right road boundary line RL, by displaying the own vehicle icon I1 and the arrow C1 on the LKAS guidance screen G2.

(f) of FIG. 4 shows an example of the LKAS performed by the first control unit 34 when the oncoming lane OL and the central division line CL are present on the roadway RD and the left road boundary line LL, the central division line CL, and the right road boundary line RL are recognized as the division line L by the recognition unit 32.

In this case, the first control unit 34 performs the LKAS using the left road boundary line LL and the central division line CL. Specifically, in this case, the first control unit 34 treats a region from the left road boundary line LL to the central division line CL as the own lane SL, and controls the steering of the vehicle 1 such that the vehicle 1 travels while maintaining near a center in the width direction of the region from the left road boundary line LL to the central division line CL (see an arrow C2 in (f) of FIG. 4). That is, in this case, the right road boundary line RL is not used for the LKAS by the first control unit 34.

When the LKAS in the example shown in (f) of FIG. 4 is performed, the display control unit 33 displays the left road boundary line LL and the central division line CL in the first display mode indicating that the left road boundary line LL and the central division line CL are used for the LKAS on the LKAS guidance screen G2, and guides the driver that the region from the left road boundary line LL to the central division line CL is treated as the own lane SL (in other words, the travel region DA). Meanwhile, in the LKAS guidance screen G2 in this case, the display control unit 33 displays the right road boundary line RL in a second display mode (for example, a display color of white) different from that of the first display mode. Accordingly, the driver can easily grasp the left road boundary line LL and the central division line CL used for the LKAS and the right road boundary line RL not used for the LKAS from the LKAS guidance screen G2.

In this case, the display control unit 33 may guide the driver that the vehicle 1 is traveling while maintaining near the center in the width direction of the region from the left road boundary line LL to the central division line CL, by displaying the own vehicle icon I1 and the arrow C2 on the LKAS guidance screen G2.

(g) of FIG. 4 shows an example of the LKAS performed by the first control unit 34 when the oncoming lane OL is present on the roadway RD, but the central division line CL is not present, and the left road boundary line LL and the right road boundary line RL are recognized as the division line L by the recognition unit 32.

In this case, the first control unit 34 performs the LKAS preferentially using the left road boundary line LL over the right road boundary line RL. For example, in this case, the first control unit 34 performs the LKAS using only the left road boundary line LL in the left road boundary line LL and the right road boundary line RL. Specifically, in this case, the first control unit 34 controls the steering of the vehicle 1 such that the vehicle 1 travels while maintaining near a line offset by half of the vehicle width W (that is, the vehicle width W/2) from the left road boundary line LL toward the right road boundary line RL side in the width direction of the roadway RD (see an arrow C3 in (g) of FIG. 4).

However, an offset amount in this case is not limited to the vehicle width W/2, and may be, for example, obtained by adding a predetermined margin (for example, 50 [cm]) to the vehicle width W/2. The offset amount in this case may vary depending on a width of the roadway RD, the presence or absence of the oncoming vehicle, or the like. As an example, the offset amount when the width of the roadway RD is relatively large may be larger than the offset amount when the width of the roadway RD is relatively small. As another example, the offset amount when no oncoming vehicle is present may be larger than the offset amount when an oncoming vehicle is present.

When the LKAS in the example shown in (g) of FIG. 4 is performed, the display control unit 33 displays the left road boundary line LL in the first display mode indicating that the left road boundary line LL is used for the LKAS on the LKAS guidance screen G2, and guides the driver that the travel region DA in the example shown in (c) of FIG. 3 is treated as the own lane SL. Meanwhile, in the LKAS guidance screen G2 in this case, the display control unit 33 displays the right road boundary line RL in the second display mode as in the example shown in (f) of FIG. 4. Accordingly, the driver can easily recognize the left road boundary line LL used for the LKAS and the right road boundary line RL not used for the LKAS from the LKAS guidance screen G2.

In this case, the display control unit 33 may show the driver that the vehicle 1 is traveling while maintaining near the above line, by displaying the own vehicle icon I1 and the arrow C3 on the LKAS guidance screen G2.

Although not shown, when the oncoming vehicle is recognized by the recognition unit 32 in a case where the LKAS in the example shown in (g) of FIG. 4 is performed, the display control unit 33 may display the same division mark M as in the example shown in (d) of FIG. 3 on the LKAS guidance screen G2. Further, when the division mark M is displayed in this way, the first control unit 34 may perform the LKAS using the left road boundary line LL and the division mark M, for example. Specifically, in this case, the first control unit 34 may treat a region between the left road boundary line LL and the division mark M as the own lane SL, and control the steering of the vehicle 1 such that the vehicle 1 travels while maintaining near a center in the width direction of the region.

### RDM IN PRESENT EMBODIMENT

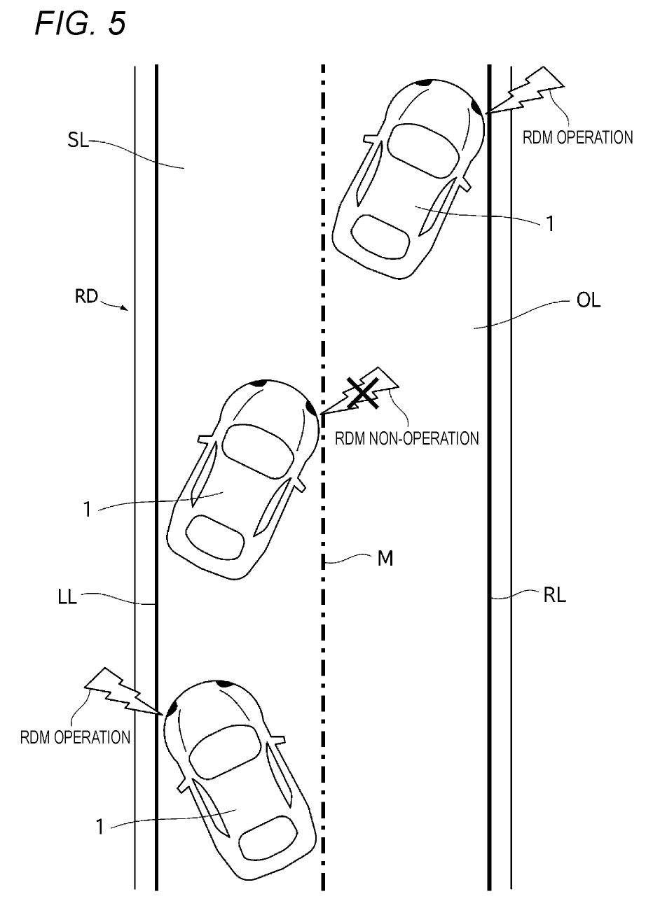

Next, a specific example of the RDM in the present embodiment will be described with reference to FIG. 5. In an example shown in FIG. 5, the vehicle 1 is traveling on the roadway RD in which the oncoming lane OL is present and the central division line CL is not present. In such a case, as shown in (d) of FIG. 3, the division mark M can be displayed on the travel region guidance screen G1.

In the example shown in FIG. 5, the second control unit 35 uses the left road boundary line LL and the right road boundary line RL for the RDM. Specifically, the second control unit 35 operates the RDM when the vehicle 1 approaches the left road boundary line LL (that is, when there is a risk that the vehicle 1 departs to the road outside beyond the left road boundary line LL) and when the vehicle 1 approaches the right road boundary line RL (that is, when there is a risk that the vehicle 1 departs to the road outside beyond the right road boundary line RL).

Meanwhile, even if the division mark M described above is displayed, the second control unit 35 does not use the division mark M for the RDM. This is because the division mark M is not the division line L recognized by the recognition unit 32 but is merely virtual, and may not be suitable to be used for the RDM.

### PROCESS PERFORMED BY CONTROL DEVICE (PART 1)

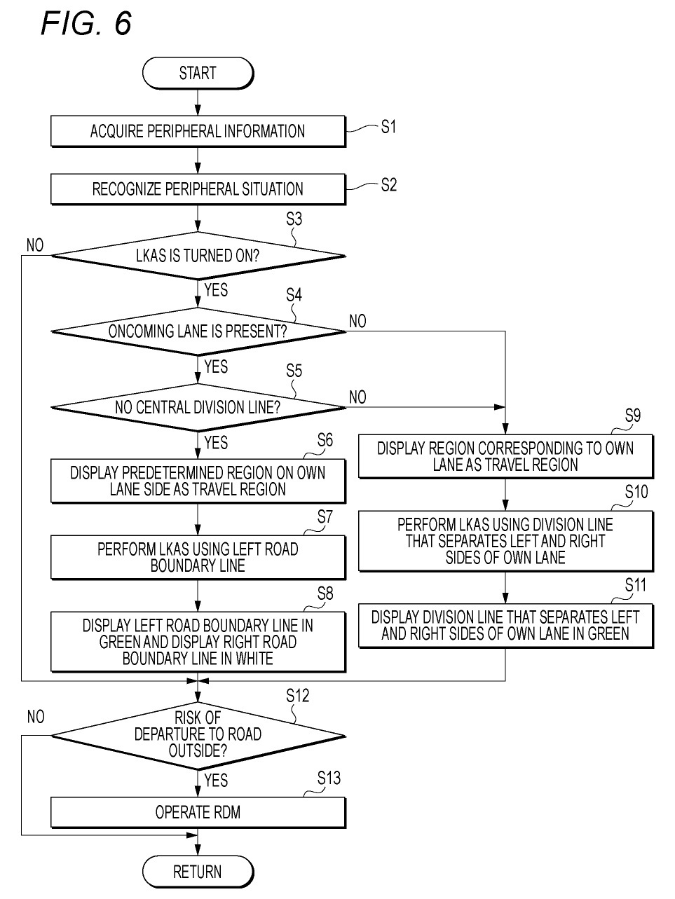

Next, an example of a process performed by the control device 30 will be described with reference to FIG. 6. For example, when an ignition power supply of the vehicle 1 is turned on, the control device 30 repeatedly performs a series of processing shown in FIG. 6 at a predetermined cycle.

As shown in FIG. 6, the control device 30 acquires the peripheral information (step S1), recognizes the peripheral situation of the vehicle 1 based on the peripheral information (step S2), and proceeds to processing in step S3. Here, it is assumed that at least the left road boundary line LL and the right road boundary line RL are recognized by the processing in step S2.

Next, the control device 30 determines whether the LKAS is turned on (in operation) (step S3). If it is determined that the LKAS is turned off (in non-operation) (step S3: NO), the control device 30 proceeds to processing in step S12 to be described later. In this case, the control device 30 may display the travel region guidance screen G1 described above on the MID 91 or the like.

On the other hand, if it is determined that LKAS is turned on (step S3: YES), the control device 30 determines whether the oncoming lane OL is present (step S4). Then, if it is determined that the oncoming lane OL is present (step S4: YES), the control device 30 determines whether there is no central division line CL that separates the own lane SL and the oncoming lane OL (step S5).

If it is determined that there is no central division line CL (step S5: YES), the control device 30 displays a predetermined region on the own lane SL side between the left road boundary line LL and the right road boundary line RL of the roadway RD on the LKAS guidance screen G2 as the travel region DA (that is, the own lane SL) (step S6), and performs the LKAS using the left road boundary line LL (step S7). Further, the control device 30 displays the left road boundary line LL in green (that is, the first display mode) and displays the right road boundary line RL in white (that is, the second display mode) (step S8), and proceeds to the processing in step S12 to be described later.

On the other hand, if it is determined in the processing of step S4 that the oncoming lane OL is not present (step S4: NO), or if it is determined in the processing of step S5 that there is the central division line CL (step S5: NO), the control device 30 displays a region corresponding to the own lane SL as the travel region DA (step S9).

Then, the control device 30 performs the LKAS using the division line L that separates left and right sides of the own lane SL (step S10), displays the division line L that separates the left and right sides of the own lane SL in green (step S11), and proceeds to the processing in step S12 to be described later. Here, the division line L that separates the left and right sides of the own lane SL can be, for example, the left road boundary line LL and the right road boundary line RL when the oncoming lane OL is not present, and can be the left road boundary line LL and the central division line CL when there is no central division line CL.

Next, the control device 30 determines whether there is a risk that the vehicle 1 departs to the road outside (that is, the outside of the roadway RD) (step S12). If it is determined that there is a risk that the vehicle 1 departs to the road outside (step S12: YES), the control device 30 operates the RDM (step S13) and ends the series of processing. On the other hand, if it is determined that there is no risk that the vehicle 1 departs to the road outside (step S12: NO), the control device 30 ends the series of processing.

### PROCESSING PERFORMED BY CONTROL DEVICE (PART 2)

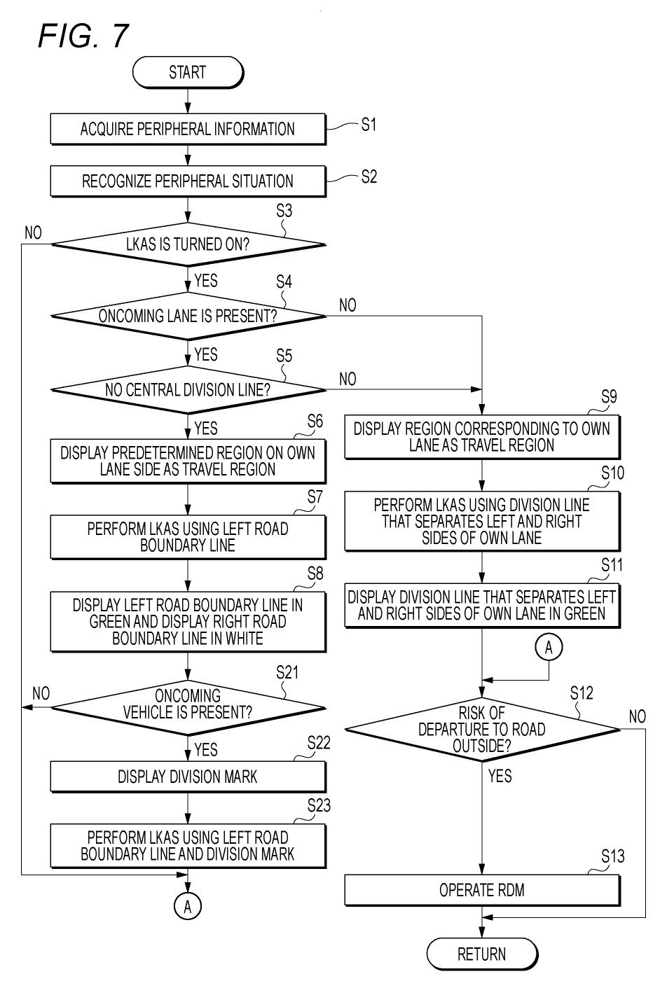

Next, another example of the process performed by the control device 30 will be described with reference to FIG. 7. That is, the control device 30 may perform a series of processing shown in FIG. 7 instead of the series of processing shown in FIG. 6. Hereinafter, among the series of processing shown in FIG. 7, processing common to the processing shown in FIG. 6 is denoted by the same reference numeral, and a description thereof will be appropriately omitted or simplified.

As shown in FIG. 7, the control device 30 acquires the peripheral information (step S1), recognizes the peripheral situation of the vehicle 1 (step S2), and determines whether the LKAS is turned on (in operation) (step S3). If it is determined that the LKAS is turned off (in non-operation) (step S3: NO), the control device 30 proceeds to the processing in step S12 to be described later. In this case, the control device 30 may display the travel region guidance screen G1 described above on the MID 91 or the like.

On the other hand, if it is determined that LKAS is turned on (step S3: YES), the control device 30 determines whether the oncoming lane OL is present (step S4). Then, if it is determined that the oncoming lane OL is present (step S4: YES), the control device 30 determines whether there is the central division line CL that separates the own lane SL and the oncoming lane OL (step S5).

If it is determined that there is no central division line CL (step S5: YES), the control device 30 displays a predetermined region on the own lane SL side between the left road boundary line LL and the right road boundary line RL of the roadway RD on the LKAS guidance screen G2 as the travel region DA (that is, the own lane SL) (step S6), and performs the LKAS using the left road boundary line LL (step S7). The control device 30 displays the left road boundary line LL in green and the right road boundary line RL in white (step S8).

Next, the control device 30 determines whether the oncoming vehicle is present (step S21). If it is determined that the oncoming vehicle is not present (step S21: NO), the control device 30 directly proceeds to the processing in step S12 to be described later.

If it is determined that the oncoming vehicle is present (step S21: YES), the control device 30 displays the division mark M (step S22), performs the LKAS using the left road boundary line LL and the division mark M (step S23), and proceeds to the processing in step S12. When the LKAS is performed using the left road boundary line LL and the division mark M, the control device 30 may also display the division mark M in addition to the left road boundary line LL in a display mode indicating that the division mark M is used for the LKAS (in other words, a display mode different from that in normal time in which the division mark M is not used for the LKAS).

On the other hand, if it is determined in the processing of step S4 that the oncoming lane OL is not present (step S4: NO), or if it is determined in the processing of step S5 that there is the central division line CL (step S5: NO), the control device 30 displays a region corresponding to the own lane SL as the travel region DA (step S9).

Then, the control device 30 performs the LKAS using the division line L that separates the left and right sides of the own lane SL (step S10), displays the division line L that separates the left and right sides of the own lane SL in green (step S11), and proceeds to the processing in step S12.

Next, the control device 30 determines whether there is a risk that the vehicle 1 departs to the road outside (that is, the outside of the roadway RD) (step S12). If it is determined that there is a risk that the vehicle 1 departs to the road outside (step S12: YES), the control device 30 operates the RDM (step S13) and ends the series of processing. On the other hand, if it is determined that there is no risk that the vehicle 1 departs to the road outside (step S12: NO), the control device 30 ends the series of processing.

### EFFECTS OF PRESENT EMBODIMENT

As described above, the control device 30 includes the display control unit 33 that guides the occupant (for example, the driver) of the vehicle 1 to the travel region DA by displaying the travel region DA ahead of the vehicle 1 in the travel direction on the display unit such as the MID 91 based on the recognition result of the recognition unit 32 that recognizes the peripheral situation of the vehicle 1. Then, in a predetermined situation in which the oncoming lane OL is present on the roadway RD and the central division line CL that separates the own lane SL and the oncoming lane OL is not present (or the central division line CL cannot be detected), the display control unit 33 displays a predetermined region on the own lane SL side between the left road boundary line LL and the right road boundary line RL of the roadway RD as the travel region DA and displays a region on the oncoming lane OL side with respect to the predetermined region as the non-travel region NA (for example, see (b) of FIG. 2 and (c) of FIG. 3). Accordingly, even if the central division line CL is not present on the roadway RD (or the central division line CL cannot be detected), an appropriate region conforming to traffic rules (for example, regulations or customs) of a region where the roadway RD is provided can be shown to the occupant as the travel region DA, and the vehicle 1 can be assisted in traveling in the appropriate region. Further, it is possible to improve traffic safety and contribute to development of a sustainable transportation system.

In the predetermined situation described above, the display control unit 33 can display the travel region DA reduced in the width direction of the roadway RD as compared with when the oncoming lane OL is not present on the roadway RD (for example, see (b) of FIG. 2). Accordingly, even if the central division line CL is not present on the roadway RD (or the central division line CL cannot be detected), it is possible to guide the occupant in an intuitively easy-to-understand manner that the oncoming lane OL is present by the travel region DA displayed in a reduced size in the width direction of the roadway RD.

Further, in the predetermined situation described above, the display control unit 33 can display, as the travel region DA, a predetermined region including the first region DA1 on the own lane SL side with respect to the center in the width direction of the roadway RD and the second region DA2 on the oncoming lane OL side with respect to the center in the width direction of the roadway RD (see, for example, (b) of FIG. 2 and (c) of FIG. 3). Accordingly, even if the central division line CL is not present on the roadway RD (or the central division line CL cannot be detected), an appropriate region conforming to the traffic rules of the region where the roadway RD is provided can be shown to the occupant as the travel region DA, and the vehicle 1 can be assisted in traveling in the appropriate region.

The first region DA1 is wider than the second region DA2 in the width direction of the roadway RD (see, for example, (b) of FIG. 2 and (c) of FIG. 3). Accordingly, the travel region DA that matches a sense of the occupant can be shown to the occupant while considering the traffic rules of the region where the roadway RD is provided.

Further, the display control unit 33 can display a predetermined region including the first region DA1 and the second region DA2 as the travel region DA when the oncoming vehicle is not present in the predetermined situation described above, and can display a predetermined region including the first region DA1 and not including the second region DA2 as the travel region DA when the oncoming vehicle is present in the predetermined situation described above (for example, see (c) of FIG. 3 and (d) of FIG. 3). Accordingly, the travel region DA that matches a sense of the occupant can be shown to the occupant when the oncoming vehicle is not present, and when the oncoming vehicle is present, it is possible to enhance consciousness of the driver to cause the vehicle 1 to travel in a region closer to the own lane SL side, and to assist the driving in consideration of the oncoming vehicle.

Further, the control device 30 includes the first control unit 34 that can perform, based on the road boundary lines in the periphery of the vehicle 1 recognized by the recognition unit 32, the first control (for example, the LKAS) including at least one of the steering control or the acceleration and deceleration control for causing the vehicle 1 to travel along the own lane SL. In the predetermined situation described above, the first control unit 34 can perform the first control preferentially using, among the left road boundary line LL and the right road boundary line RL of the roadway RD, the road boundary line on the own lane SL side (for example, the left road boundary line LL) over the road boundary line on the oncoming lane OL side (for example, the right road boundary line RL) (for example, see (g) of FIG. 4). That is, when the predetermined situation occurs, the road boundary line on the oncoming lane OL side may not be a road boundary line for separating the own lane SL, and thus may not be suitable to be used for the first control. Therefore, in the predetermined situation, the first control can be appropriately performed by performing the first control preferentially using the road boundary line on the own lane SL side over the road boundary line on the oncoming lane OL side.

Further, the display control unit 33 can display the road boundary lines in the periphery of the vehicle 1 on the display unit such as the MID 91 when the first control is performed by the first control unit 34, and can display the road boundary line on the own lane SL side in a display mode different from that of the road boundary line on the oncoming lane OL side when the first control in which the road boundary line on the own lane SL side is preferentially used over the road boundary line on the oncoming lane OL side is performed (for example, see (g) of FIG. 4). In this way, when the first control in which the road boundary line on the own lane SL side is preferentially used over the road boundary line on the oncoming lane OL side is performed, by displaying the road boundary line on the own lane SL side in a display mode different from that of the road boundary line on the oncoming lane OL side, the road boundary line used for the first control can be shown to the occupant in an intuitively easy-to-understand manner.

Further, the control device 30 includes the second control unit 35 that can perform the second control (for example, the RDM) including at least one of the predetermined steering control, the acceleration and deceleration control, or the notification when the vehicle 1 approaches the road boundary line based on the road boundary lines in the periphery of the vehicle 1 recognized by the recognition unit 32. In the predetermined situation described above, the second control unit 35 can perform the second control using the road boundary lines on the left and right sides of the roadway RD (for example, see FIG. 5). Accordingly, even if the predetermined situation occurs, the departure of the vehicle 1 from the roadway RD can be mitigated by the second control.

Further, when an oncoming vehicle is present in the predetermined situation described above, the display control unit 33 can display the division mark M that separates the own lane SL and the oncoming lane OL in the width direction of the roadway RD on the display unit such as a MID 91 (for example, see (d) in FIG. 3). In this way, by displaying the division mark M when an oncoming vehicle is present, it is possible to enhance consciousness of the driver to cause the vehicle 1 to travel in a region closer to the own lane SL (for example, the left road boundary line LL) side on the roadway RD, and to assist the driving in consideration of the oncoming vehicle.

Further, when the division mark M is displayed, the display control unit 33 can display a predetermined region including the first region DA1 on the own lane SL side with respect to the division mark M as the travel region DA (for example, see (d) of FIG. 3). Accordingly, when the division mark M is displayed, a region the same as when the central division line CL is present can be shown to the occupant as the travel region DA.

Further, when the division mark M is displayed, the first control unit 34 can perform the first control using the road boundary line on the own lane SL side and the division mark M. Accordingly, a region between the road boundary line on the own lane SL side and the division mark M can be treated as the own lane SL, and the vehicle 1 can be assisted in traveling along the region.

Further, the second control unit 35 can prevent the division mark M from being used for the second control. Accordingly, the division mark M, which is merely virtual, can be prevented from being used for the second control, and the second control can be appropriately performed using only the actual road boundary lines.

The control method described in the above embodiment may be implemented by executing a program prepared in advance on a computer. For example, the present program is stored in a computer-readable storage medium and executed by being read from the storage medium. Further, the present program may be provided in a form of being stored in a nonvolatile (non-transitory) storage medium such as a flash memory, or may be provided via a network such as the Internet.

Although an embodiment of the present disclosure has been described above with reference to the drawings, it goes without saying that the present disclosure is not limited to the embodiment described above. It is apparent that those skilled in the art can conceive of various modifications and alterations within the scope described in the claims, and it is understood that such modifications and alterations naturally fall within the technical scope of the present disclosure. Further, the constituent elements in the above embodiments may be freely combined without departing from the gist of the disclosure.

In the present description and the like, at least the following matters are described. Although corresponding constituent elements in the embodiments described above are shown in parentheses, the present disclosure is not limited thereto.

(1) A vehicle control device (control device 30) for controlling a vehicle (vehicle 1), including:

an acquisition unit (acquisition unit 31) configured to acquire peripheral information of the vehicle;

a recognition unit (recognition unit 32) configured to recognize a peripheral situation of the vehicle based on the peripheral information acquired by the acquisition unit; and

a display control unit (display control unit 33) configured to guide, to an occupant of the vehicle, a travel region (travel region DA) ahead of the vehicle in a travel direction thereof by displaying the travel region on a display unit (MID 91) of the vehicle based on a recognition result of the recognition unit, in which

in a predetermined situation in which an oncoming lane (oncoming lane OL) whose travel direction is opposite to that of an own lane (own lane SL) in which the vehicle travels is present on a roadway (roadway RD) including the own lane, and a central division line (central division line CL) that separates the own lane and the oncoming lane is not present or the central division line is not able to be detected,

the display control unit displays, as the travel region, a predetermined region on an own lane side between road boundary lines (left road boundary line LL and right road boundary line RL) on left and right sides of the roadway, and displays a region on an oncoming lane side with respect to the predetermined region as a non-travel region (non-travel region NA) that is not the travel region.

According to (1), even if the central division line is not present on the roadway or the central division line cannot be detected, an appropriate region conforming to traffic rules (for example, regulations or customs) of a region where the roadway is provided can be guided to the occupant as the travel region, and the vehicle can be assisted in traveling in the appropriate region. Further, it is possible to improve traffic safety and contribute to development of a sustainable transportation system.

(2) The vehicle control device according to (1), in which

in the predetermined situation, the display control unit displays the travel region reduced in a width direction of the roadway as compared with when the oncoming lane is not present on the roadway.

According to (2), even if the central division line is not present on the roadway or the central division line cannot be detected, it is possible to guide the occupant in an intuitively easy-to-understand manner that the oncoming lane is present by the travel region displayed in a reduced size in the width direction of the roadway.

(3) The vehicle control device according to (1), in which

in the predetermined situation, the display control unit displays, as the travel region, the predetermined region including a first region (first region DA1) on the own lane side with respect to a center in a width direction of the roadway and a second region (second region DA2) on the oncoming lane side with respect to the center.

According to (3), even if the central division line is not present on the roadway or the central division line cannot be detected, an appropriate region conforming to the traffic rules of the region where the roadway is provided can be guided to the occupant as the travel region, and the vehicle can be assisted in traveling in the appropriate region.

(4) The vehicle control device according to (3), in which

the first region is wider than the second region in the width direction.

According to (4), the travel region that matches a sense of the occupant can be guided to the occupant while considering the traffic rules of the region where the roadway is provided.

(5) The vehicle control device according to (3), in which

the display control unit

displays the predetermined region including the first region and the second region as the travel region when an oncoming vehicle whose travel direction is opposite to that of the vehicle is not present in the predetermined situation, and

displays the predetermined region including the first region and not including the second region as the travel region when the oncoming vehicle is present in the predetermined situation.

According (5), the travel region that matches a sense of the occupant can be guided to the occupant when the oncoming vehicle is not present, and when the oncoming vehicle is present, it is possible to enhance consciousness of the driver to cause the vehicle to travel in a region closer to the own lane side, and to assist the driving in consideration of the oncoming vehicle.

(6) A vehicle control device (control device 30) for controlling a vehicle (vehicle 1), including:

an acquisition unit (acquisition unit 31) configured to acquire peripheral information of the vehicle;

a recognition unit (recognition unit 32) configured to recognize a peripheral situation of the vehicle based on the peripheral information acquired by the acquisition unit; and

a first control unit (first control unit 34) configured to perform first control including at least one of steering control or acceleration and deceleration control for causing the vehicle to travel along an own lane (own lane SL) based on road boundary lines (left road boundary line LL, right road boundary line RL) in a periphery of the vehicle recognized by the recognition unit, in which

in a predetermined situation in which an oncoming lane (oncoming lane OL) whose travel direction is opposite to that of the own lane in which the vehicle travels is present on a roadway including the own lane and a central division line (central division line CL) that separates the own lane and the oncoming lane is not present or the central division line is not able to be detected,

the first control unit performs the first control preferentially using, among the road boundary lines on left and right sides of the roadway, the road boundary line on an own lane side over the road boundary line on an oncoming lane side.

According to (6), in the predetermined situation, the first control can be appropriately performed by performing the first control preferentially using the road boundary line on the own lane side over the road boundary line on the oncoming lane side.

(7) The vehicle control device according to (6) further including:

a display control unit (display control unit 33) configured to display the road boundary lines on a display unit when the first control is performed by the first control unit, in which

the display control unit displays the road boundary line on the own lane side in a display mode different from that of the road boundary line on the oncoming lane side, when the first control in which the road boundary line on the own lane side is used preferentially over the road boundary line on the oncoming lane side is performed.

According to (7), when the first control in which the road boundary line on the own lane side is preferentially used over the road boundary line on the oncoming lane side is performed, by displaying the road boundary line on the own lane side in a display mode different from that of the road boundary line on the oncoming lane side, the road boundary line used for the first control can be guided to the occupant in an intuitively easy-to-understand manner.

(8) The vehicle control device according to (1) further including:

a second control unit (second control unit 35) configured to perform, based on the road boundary lines in a periphery of the vehicle recognized by the recognition unit, second control including at least one of predetermined steering control, acceleration and deceleration control, or notification when the vehicle approaches one of the road boundary lines, in which

the second control unit performs the second control using the road boundary lines on the left and right sides in the predetermined situation.

According to (8), even if the predetermined situation occurs, departure of the vehicle from the roadway can be mitigated by the second control.

(9) The vehicle control device according to any one of (1) to (5), in which

the display control unit displays, on the display unit, a division mark (division mark M) that separates the own lane and the oncoming lane in a width direction of the roadway, when an oncoming vehicle whose travel direction is opposite to that of the vehicle is present in the predetermined situation.

According to (9), by displaying the division mark when an oncoming vehicle is present, it is possible to enhance the consciousness of the driver to cause the vehicle to travel in a region closer to the own lane side with respect to the center in the width direction of the roadway, and to assist the driving in consideration of the oncoming vehicle.

(10) The vehicle control device according to (9), in which

when the division mark is displayed, the display control unit displays, as the travel region, the predetermined region including a first region on the own lane side with respect to the division mark.

According to (10), when the division mark is displayed, a region the same as when the central division line is present can be guided to the occupant as the travel region.

(11) The vehicle control device according to (9) further including:

a first control unit configured to perform, based on the road boundary lines in a periphery of the vehicle recognized by the recognition unit or the division mark, first control including at least one of steering control or acceleration and deceleration control for causing the vehicle to travel along the own lane, in which

when the division mark is displayed, the first control unit performs the first control using the division mark and the road boundary line on the own lane side among the road boundary lines on the left and right sides.

According to (11), a region between one of the road boundary lines and the division mark can be treated as the own lane, and the vehicle can be assisted in traveling along the region.

(12) The vehicle control device according to (9) further including:

a second control unit configured to perform, based on the road boundary lines in a periphery of the vehicle recognized by the recognition unit, second control including at least one of predetermined steering control, acceleration and deceleration control, or notification when the vehicle approaches one of the road boundary lines, in which

the second control unit does not use the division mark for the second control.

According to (12), the division mark, which is merely virtual, can be prevented from being used for the second control, and the second control can be appropriately performed using only the actual road boundary lines.

(13) A control method to be performed by a computer (control device 30) for controlling a vehicle (vehicle 1), the control method including the computer performing processing of:

acquiring peripheral information of the vehicle (step S1);

recognizing a peripheral situation of the vehicle based on the acquired peripheral information (step S2); and

guiding, to an occupant of the vehicle, a travel region (travel region DA) ahead of the vehicle in a travel direction thereof by displaying the travel region on a display unit (MID 91) of the vehicle based on a recognition result for the peripheral situation (step S6 and step S9), in which

in the processing of guiding the travel region,

in a predetermined situation in which an oncoming lane (oncoming lane OL) whose travel direction is opposite to that of an own lane (own lane SL) in which the vehicle travels is present on a roadway (roadway RD) including the own lane, and a central division line (central division line CL) that separates the own lane and the oncoming lane is not present or the central division line is not able to be detected,

a predetermined region on an own lane side between road boundary lines (left road boundary line LL and right road boundary line RL) on left and right sides of the roadway is displayed as the travel region, and a region on an oncoming lane side with respect to the predetermined region is displayed as a non-travel region (non-travel region NA) that is not the travel region (step S6).

According to (13), even if the central division line is not present on the roadway or the central division line cannot be detected, an appropriate region conforming to the traffic rules (for example, the regulations or the customs) of the region where the roadway is provided can be guided to the occupant as the travel region, and the vehicle can be assisted in traveling in the appropriate region. Further, it is possible to improve the traffic safety and contribute to the development of the sustainable transportation system.

(14) A control method to be performed by a computer (control device 30) for controlling a vehicle (vehicle 1), the control method including the computer performing processing of:

acquiring peripheral information of the vehicle (step S1);

recognizing a peripheral situation of the vehicle based on the acquired peripheral information (step S2); and

performing first control including at least one of steering control or acceleration and deceleration control for causing the vehicle to travel along an own lane based on recognized road boundary lines in a periphery of the vehicle (step S7), in which

in the processing of performing the first control,

in a predetermined situation in which an oncoming lane (oncoming lane OL) whose travel direction is opposite to that of the own lane (own lane SL) in which the vehicle travels is present on a roadway (roadway RD) including the own lane and a central division line (central division line CL) that separates the own lane and the oncoming lane is not present or the central division line is not able to be detected,

the first control is performed preferentially using, among the road boundary lines (left road boundary line LL and right road boundary line RL) on left and right sides of the roadway, the road boundary line on an own lane side over the road boundary line on an oncoming lane side.

According to (14), in the predetermined situation, the first control can be appropriately performed by performing the first control preferentially using the road boundary line on the own lane side over the road boundary line on the oncoming lane side.

1. A vehicle control device for controlling a vehicle, comprising:
a processor configured to:
acquire peripheral information of the vehicle;
recognize a peripheral situation of the vehicle based on the acquired peripheral information; and
a display controller configured to guide an occupant of the vehicle to a travel region ahead of the vehicle in a travel direction thereof by displaying the travel region on a display of the vehicle based on a recognition result, wherein
in a predetermined situation in which an oncoming lane whose travel direction is opposite to that of an own lane in which the vehicle travels is present on a roadway including the own lane, and a central division line that separates the own lane and the oncoming lane is not present or the central division line is not able to be detected,
the display controller displays, as the travel region, a predetermined region on an own lane side between road boundary lines on left and right sides of the roadway, and displays a region on an oncoming lane side with respect to the predetermined region as a non-travel region that is not the travel region.

2. The vehicle control device according to claim 1, wherein
in the predetermined situation, the display controller displays the travel region reduced in a width direction of the roadway as compared with when the oncoming lane is not present on the roadway.

3. The vehicle control device according to claim 1, wherein
in the predetermined situation, the display controller displays, as the travel region, the predetermined region including a first region on the own lane side with respect to a center in a width direction of the roadway and a second region on the oncoming lane side with respect to the center.

4. The vehicle control device according to claim 3, wherein
the first region is wider than the second region in the width direction.

5. The vehicle control device according to claim 3, wherein
the display controller displays the predetermined region including the first region and the second region as the travel region when an oncoming vehicle that travels in the oncoming lane is not present in the predetermined situation, and
the display controller displays the predetermined region including the first region and not including the second region as the travel region when the oncoming vehicle is present in the predetermined situation.

6. A vehicle control device for controlling a vehicle, comprising:
a processor configured to:
acquire peripheral information of the vehicle;
recognize a peripheral situation of the vehicle based on the acquired peripheral information acquired; and
perform first control including at least one of steering control or acceleration and deceleration control for causing the vehicle to travel along an own lane based on road boundary lines in a periphery of the vehicle, wherein
in a predetermined situation in which an oncoming lane whose travel direction is opposite to that of the own lane in which the vehicle travels is present on a roadway including the own lane and a central division line that separates the own lane and the oncoming lane is not present or the central division line is not able to be detected,
the processor performs the first control preferentially using, among the road boundary lines on left and right sides of the roadway, the road boundary line on an own lane side over the road boundary line on an oncoming lane side.

7. The vehicle control device according to claim 6, further comprising
a display controller configured to display the road boundary lines on a display when the first control is performed by the processor, wherein
the display controller displays the road boundary line on the own lane side in a display mode different from that of the road boundary line on the oncoming lane side, when the first control in which the road boundary line on the own lane side is used preferentially over the road boundary line on the oncoming lane side is performed.

8. The vehicle control device according to claim 1, wherein
the processor performs, based on the road boundary lines in a periphery of the vehicle, second control including at least one of predetermined steering control, acceleration and deceleration control, or notification when the vehicle approaches one of the road boundary lines, and
the processor performs the second control using the road boundary lines on the left and right sides in the predetermined situation.

9. The vehicle control device according to claim 1, wherein
the display controller displays, on the display, a division mark that separates the own lane and the oncoming lane in a width direction of the roadway, when an oncoming vehicle that travels in the oncoming lane is present in the predetermined situation.

10. The vehicle control device according to claim 9, wherein
when the division mark is displayed, the display controller displays, as the travel region, the predetermined region including a first region on the own lane side with respect to the division mark.

11. The vehicle control device according to claim 9, wherein
the processor performs, based on the road boundary lines in a periphery of the vehicle recognized by the recognition unit or the division mark, first control including at least one of steering control or acceleration and deceleration control for causing the vehicle to travel along the own lane, wherein
when the division mark is displayed, the processor performs the first control using the division mark and the road boundary line on the own lane side among the road boundary lines on the left and right sides.

12. The vehicle control device according to claim 9, wherein
the processor performs, based on the road boundary lines in a periphery of the vehicle recognized by the recognition unit, second control including at least one of predetermined steering control, acceleration and deceleration control, or notification when the vehicle approaches one of the road boundary lines, wherein
the processor does not use the division mark for the second control.

13. A control method to be performed by a computer for controlling a vehicle, the control method comprising:
acquiring peripheral information of the vehicle;
recognizing a peripheral situation of the vehicle based on the acquired peripheral information; and
guiding an occupant of the vehicle to a travel region ahead of the vehicle in a travel direction thereof by displaying the travel region on a display unit of the vehicle based on a recognition result for the peripheral situation, wherein
the guiding comprises:
in a predetermined situation in which an oncoming lane whose travel direction is opposite to that of an own lane in which the vehicle travels is present on a roadway including the own lane, and a central division line that separates the own lane and the oncoming lane is not present or the central division line is not able to be detected,
displaying a predetermined region on an own lane side between road boundary lines on left and right sides of the roadway as the travel region, and displaying a region on an oncoming lane side with respect to the predetermined region as a non-travel region that is not the travel region.

14. A control method to be performed by a computer for controlling a vehicle, the control method comprising:
acquiring peripheral information of the vehicle;
recognizing a peripheral situation of the vehicle based on the acquired peripheral information; and
performing first control including at least one of steering control or acceleration and deceleration control for causing the vehicle to travel along an own lane based on recognized road boundary lines in a periphery of the vehicle, wherein
the performing comprises:
in a predetermined situation in which an oncoming lane whose travel direction is opposite to that of the own lane in which the vehicle travels is present on a roadway including the own lane and a central division line that separates the own lane and the oncoming lane is not present or the central division line is not able to be detected,
performing the first control preferentially using, among the road boundary lines on left and right sides of the roadway, the road boundary line on an own lane side over the road boundary line on an oncoming lane side.
